(19) United States
(12) Patent Application Publication
(10) Pub. No.: US 2024/0281666 A1
(43) Pub. Date: Aug. 22, 2024

(54) Control of an Electricity Supply Network

(71) Applicant: Siemens Aktiengesellschaft, München (DE)

(72) Inventors: Mathias Duckheim, Erlangen (DE); Michael Metzger, Markt Schwaben (DE)

(73) Assignee: Siemens Aktiengesellschaft, München (DE)

(21) Appl. No.: 18/570,086

(22) PCT Filed: Jun. 10, 2022
(86) PCT No.: PCT/EP2022/065805

§ 371 Date: Dec. 14, 2023

(30) Foreign Application Priority Data
Jun. 14, 2021 (EP) 21179287.4

(51) Int. Cl. G06N 3/092; H02J 3/00

(52) U.S. Cl. CPC G06N 3/092; H02J 3/001

(57) ABSTRACT

Various embodiments of the teachings herein include a method for the reinforced learning of an artificial neural network. The neural network uses measured values associated with a supply network to determine a plurality of control values for controlling the supply network. The method may include: determining a control value so at least one limit value of a measurement variable of the supply network is violated in a time range, wherein the time range is determined in such a way that protective devices of the supply network do not trip; acquiring at least one measured value associated with the control value; and training the neural network using the calculated control value and the acquired associated measured value.

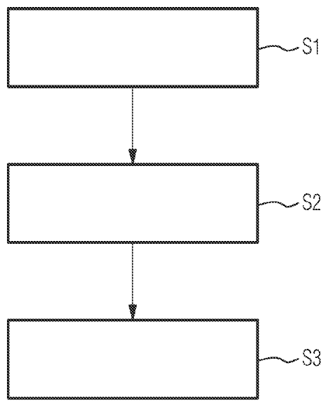

### CROSS-REFERENCE TO RELATED APPLICATIONS

This application is a U.S. National Stage Application of International Application No. PCT/EP2022/065805 filed Jun. 10, 2022, which designates the United States of America, and claims priority to EP application Ser. No. 21/179,287.4 filed Jun. 14, 2021, the contents of which are hereby incorporated by reference in their entirety.

### TECHNICAL FIELD

The present disclosure relates to supply networks. Various embodiments of the teachings herein include systems and/or methods for controlling a supply network.

### BACKGROUND

Supply networks, in particular low-voltage and medium-voltage distribution networks, must solve supply problems under new consumption and generation scenarios. The addition of photovoltaics, battery storage devices and chargers for electric vehicles leads to greater loads in the electrical network (electricity network). In addition to complicated network expansion, operating approaches which specifically control the above-mentioned consumers in critical network situations in order to avoid overloads, for example violations of the voltage band or tripping of a fuse by virtue of its maximum power (limit value) being exceeded, are attractive. These approaches can be enabled more efficiently, the more accurately the state of the supply network is known.

In contrast to transmission networks, low-voltage networks or medium-voltage networks hardly have a measuring infrastructure. In addition, there are fewer degrees of control freedom, such as the disconnection of chargers or the curtailment of photovoltaic systems or heat pumps. Interventions in the operation of these systems can be used to make better use of the already existing network. This would minimize further network expansion. The control interventions are used, for example, to avoid overloading lines in the network.

However, there are many different low-voltage networks or medium-voltage networks with significantly different combinations of consumers, generators or prosumers, with the result that a central control device for controlling the supply network, which, for example, controls a plurality of local networks simultaneously, is difficult to implement or can only be implemented with a disproportionate amount of effort. This would require a reliable, prohibitively expensive, real-time communication connection of all networks to the central control device.

It is also very difficult to implement consistently reliable and correct parameterization for a model of each local network station. In addition, associated measurements are typically not available for all state variables of the network. In summary, low-voltage networks have not been operated automatically until now due to the technical difficulties mentioned.

### SUMMARY

The teachings of the present disclosure include improved control systems and methods for a supply network, in particular a low-voltage network or a medium-voltage network. For example, some embodiments include a method for the reinforced learning of an artificial neural network, wherein the neural network uses measured values associated with a supply network, in particular with an electricity network, to determine a plurality of control values for controlling the supply network, characterized by: (S1) determining a control value such that at least one limit value of a measurement variable of the supply network is violated in a time range, wherein the time range is determined in such a way that protective devices of the supply network do not trip; (S2) acquiring at least one measured value associated with the control value; and (S3) training the neural network using the calculated control value and the acquired associated measured value.

In some embodiments, the supply network is an electricity network.

In some embodiments, the supply network is designed as a medium-voltage network and/or low-voltage network.

In some embodiments, the learning takes place during operation of the supply network.

In some embodiments, the time range is less than or equal to one minute.

In some embodiments, avoided violations of limit values are used as quality parameters of the reinforced learning.

In some embodiments, active powers, reactive powers, angles and/or currents of the respective phase at respective network nodes of the electricity network and/or in the respective lines of the electricity network are used as measured values.

In some embodiments, changes in active powers and/or reactive powers are fed into the electricity network and/or fed out due to the control values.

In some embodiments, the control values are transmitted by means of a ripple control signal and/or telecontrol signal to a smart meter and/or to a controllable mains transformer and/or to converters of photovoltaic systems and/or to charging stations.

In some embodiments,

$$r ( {s}_{t} ) = - {α}_{P} {\vert Δ P \vert}^{2} - {α}_{Q} {\vert Δ Q \vert}^{2} - {\sum }_{k} {γ}_{k} max ( 0 , {G}_{k} - {G}_{k}^{max} )$$

is used as the reward function, where Gₖ indicates measurement variable and Gₖ^{max} indicates its associated limit value, ΔP indicates a change in the active power, ΔQ indicates a change in the reactive power and sₜ=(P_{1,t}, P_{2,t}, . . . . P_{N,t}, Q_{1,t}, Q_{2,t}, . . . , Q_{N,t})^{T} indicates a state of the electricity network at the time t.

In some embodiments, the learning takes place in such a way that the reward function r(sₜ) is maximized.

In some embodiments, the neural network determines the vector aₜ=(ΔP_{1,t}, . . . , ΔP_{F,t}, ΔQ_{1,t}, . . . , ΔQ_{F,t})^{T} as control values.

In some embodiments, the learning additionally takes place with synthetic measured values, wherein the synthetic measured values are calculated by means of a state estimation.

As another example, some embodiments include an artificial neural network for controlling a supply network, in particular an electricity network, trained as described herein.

As another example, some embodiments include a control device for controlling a supply network, in particular an electricity network, comprising an artificial neural network as described herein.

### BRIEF DESCRIPTION OF THE DRAWING

Further advantages, features, and details of the teachings herein are apparent from the exemplary embodiments described below and with reference to the drawing. In this case, the single figure schematically shows a flowchart of a method incorporating teachings of the present disclosure.

Identical, equivalent, or functionally identical elements may be provided with the same reference signs in the figure.

### DETAILED DESCRIPTION

The methods described herein for the reinforced learning of an artificial neural network, wherein the neural network uses measured values associated with a supply network, in particular with an electricity network, to determine a plurality of control values for controlling the supply network, include: determining a control value such that at least one limit value of a measurement variable of the supply network is violated, in particular is exceeded or undershot, in a time range, wherein the time range is determined in such a way that protective devices of the supply network do not trip; acquiring at least one measured value associated with the control value; and training the neural network using the calculated control value and the acquired associated measured value.

The methods described herein and/or one or more functions, features and/or steps of the methods and/or of one of its embodiments may be computer-aided. In particular, the methods may be carried out by means of a computing unit. The artificial neural network is designed, especially through training, to control the supply network.

A measurement variable of the supply network is typically a state variable of the supply network, for example an active power and/or a reactive power. In addition, the term power is used as an abbreviation for an active power and/or a reactive power, in particular also for an apparent power (active power and reactive power). One or more state variables of the supply network are measured, i.e. acquired.

The artificial neural network, which is designed to control the supply network, is trained by means of self-reinforced or reinforced learning (Reinforcement Learning) during operation of the supply network. As a result, the artificial neural network learns independently during operation. The artificial neural network may already be pre-trained or untrained prior to the training described herein. The artificial neural network adapts autonomously during operation of the supply network and learns symbolically improved strategies for the operation of the supply network (improved operating strategies). The neural networks trained according to the teachings of the present disclosure therefore provide improved control of the supply network or only enables such control.

For this purpose, the artificial neural network determines one or more control values (control commands), for example voltage changes and/or power changes at nodes and/or lines of the supply network, which are the basis for the control of the supply network. In some embodiments, the control value or values determined can be determined based on a reward function for reinforced learning.

The reward function is the basis for the reinforced learning of the neural network. It defines which interventions, such as changes in voltages and/or powers, are beneficial for controlling the supply network. In other words, the neural network is trained during operation and thus during its learning in such a way that it symbolically maximizes its reward, which it receives for certain interventions under certain circumstances according to the reward function, as far as possible. For example, an intervention is always quantified as negative, with the result that the reward function has penalty terms for interventions in the operation of the supply network, for example due to changes in the voltages and/or powers. The greater the change in the control variable associated with the supply network, the less the reward. Thus, the neural network trained in this way controls the supply network by means of as few interventions as possible with as little change as possible to the existing network state.

In some embodiments, the reward function may include penalty terms for exceeding or undershooting limit values, i.e. for limit value violations. This trains the neural network in such a way that such exceeding and/or undershooting of limit values, for example maximum voltages, currents and/or powers, is avoided as far as possible. The reward function thus includes one or more penalty terms that sanction a technically undesirable control behavior. The penalty terms of the reward function can be weighted differently depending on the requirement. This weighting can change or be reset as the learning of the neural network progresses.

The teachings of the present disclosure may improve the training of the neural network and thus the control of the supply network by targeted interventions. For this purpose, control values or control commands are generated and lead to a limit value of the supply network being exceeded or undershot, i.e. to one or more limit value violations. In other words, synthetic control commands are generated, but lead to actual interventions in the operation of the supply network.

The limit value is only exceeded or undershot within a determined time range. In this case, the time range is determined according to the invention in such a way that protective devices of the supply network do not trip. As a result, the supply network can continue to be operated normally during learning of the neural network. In other words, the time range for the protective devices is determined to be so short that they remain trip-free. The length of the time range may depend on the existing protective devices and must be specified in such a way that they remain trip-free.

However, in spite of the aforementioned temporal brevity of the interventions, measured values of variables associated with the supply network, in particular voltages, currents and/or powers, which are at least partly based on the artificially generated interventions as it were, can be acquired, for example immediately after the intervention(s) took place. This symbolically tests the supply network and records its reaction to the artificially generated intervention intended in this sense for the training of the neural network. As a result, not only are more measured values or measurement data available for the training of the neural network, but at the same time peripheral areas of the control, i.e. near limit values, are examined. In other words, this samples/explores the peripheral areas of the reward function. Thus, the neuronal network trained in this way has improved control, in particular in the aforementioned peripheral areas, with the result that improved control of the supply network, also in critical situations near a limit violation, is enabled overall.

The training of the artificial neural network described herein thus technically leads to improved control of the supply network, wherein control is carried out by means of the neural network trained in this way. For control, the neural network determines one or more control values or control commands which are the basis for a change in one or more technical variables associated with the supply network, for example voltages and/or one or more powers, at one or more network nodes or within one or more lines of the supply network. The determination of the control values is based at least on one or more current measured values which are used as input for the neural network. The output of the neural network is formed by the control values.

In some embodiments, the supply network is designed as an electricity network. The supply network may be designed as a medium-voltage network and/or as a low-voltage network.

The methods described herein may be particularly advantageous for medium-voltage networks and/or low-voltage networks, since few measured values/little measurement data are typically available for these networks. More measured values/measurement data can be provided by means of the training of the neural network, which is based on synthetically generated interventions and takes place during operation of the electricity network. This means that a costly expansion of medium-voltage networks or low-voltage networks, especially with regard to measuring apparatuses, is not necessary or is significantly reduced. The neural network, which is provided and designed for controlling the medium-voltage or low-voltage network, creates symbolically its measured values/measurement data by means of the targeted synthetically generated interventions themselves and can thus continue to learn continuously during operation of the electricity network.

The artificial neural network for controlling a supply network, in particular an electricity network, is characterized in that it is trained according to one or more of the methods described herein. In particular, reinforced learning (Reinforcement Learning) may be used in this case.

In some embodiments, a control device for controlling a supply network, in particular an electricity network, comprises an artificial neural network incorporating teachings of the present disclosure. In some embodiments, the control device comprises a computing unit which is used to implement the artificial neural network.

In some embodiments, learning takes place during operation of the supply network. This eliminates the need to interrupt the operation of the supply network. This is possible because the synthetically generated interventions are generated in such a way that they do not trip protective devices of the supply network. Furthermore, the neural network trained in this way is continuously improved with regard to the control of the supply network, in particular with regard to critical situations which are characterized by limit values of the supply network being exceeded or undershot.

In some embodiments, the time range is less than or equal to one minute. In other words, the time range is set to be less than or equal to one minute. This ensures, in particular for medium-voltage networks and/or low-voltage networks, that known and installed protective devices, such as fuses, do not trip, i.e. remain trip-free.

In some embodiments, exceedances of limit values are taken into account in quality parameters of reinforced learning. In other words, it can be recorded how often the detected interventions (control values/control commands) of the neural network lead to limit values being exceeded. This can be used as a quality parameter, that is to say as a parameter that records the quality of the trained neural network. In principle, limit values should not be exceeded by control by means of the neural network. However, exceedance is not fundamentally ruled out, with the result that a neural network is better trained in this sense if this leads to fewer limit value violations during operation due to its interventions. The number of limit value exceedances within a time range and/or the magnitude of the limit value exceedances, i.e. the magnitude of the deviation from the limit value, can be used as quality parameters. A threshold value can be set for a quality parameter set in this manner. If the threshold value is exceeded, for example too many limit value exceedances took place, the training of the neural network can be discarded and the neural network can be newly trained according to the present invention and/or one of its embodiments. In other words, the reinforcement model is discarded and retrained.

In some embodiments, avoided violations, in particular exceedances, of limit values are used as quality parameters of reinforced learning.

In some embodiments, active powers, reactive powers, angles and/or currents of the respective phase at the respective network nodes of the electricity network and/or in the respective lines of the electricity network are used as measured values. As a result, technically accessible and acquirable measurement variables for an electricity network may be used for the training or learning of the neural network and for the control of the electricity network.

In some embodiments, changes in active powers and/or reactive powers are fed into the electricity network and/or fed out due to the control values. In this case, the control values determined by the neural network can correspond to the intended changes in powers. In other words, the determined changes in the powers are passed on to the respective systems connected to the electricity network and capable of feeding a power in or out, which then carry out this change with regard to their power. The neural network thus controls feed-ins into the electricity network and/or feed-outs from the electricity network.

In some embodiments, the control values or control commands are transmitted by means of a ripple control signal and/or telecontrol signal to a smart meter and/or to a controllable mains transformer and/or to converters of photovoltaic systems and/or to charging stations. This enables control by means of typical network systems. A controllable mains transformer, in particular a controllable local mains transformer, can also be used to regulate or control voltages, with the result that voltage increases and/or voltage reductions are also possible.

In some embodiments, r(sₜ)=−α_{P}|ΔP|²−α_{Q}|ΔQ|²−Σₖγₖ max(0, Gₖ−Gₖ^{max}) is used as the reward function, where Gₖ indicates a measurement variable and Gₖ^{max} indicates its associated limit value, ΔP indicates a change in the active power, ΔQ indicates a change in the reactive power and sₜ=(P_{1,t}, P_{2,t}, . . . . P_{N,t}, Q_{1,t}, Q_{2,t}, . . . , Q_{N,t})^{T} indicates a state of the electricity network at the time t.

The state of the electricity network is thus formed by the powers in the present case. Typically, the state is formed by voltage magnitudes and angles. In other words, the powers are a state variable in the present case. A power P_{i,t} or Q_{i,t} indicates the active or reactive power at a network node i at the time or within the time step t. In the present case, the electricity network has N network nodes. The active power and/or reactive power can be changed at each of the network nodes. The total changes in the active power or reactive power are represented by ΔP or ΔQ. Any intervention and therefore any change is technically undesirable in principle, with the result that the penalty terms associated with these changes have a negative sign within the reward function. The change in the active powers and the change in the reactive powers basically have different parameters α_{P} and α_{Q}. In other words, they are weighted differently within the reward function. Furthermore, limit value violations, especially with regard to a maximum permissible voltage G_{1,i}=Vᵢ^{max} and/or a maximum permissible current G_{2,l}=Iₗ^{max}, are sanctioned by the last term of the reward function, that is to say they also symbolically lead to a low reward. Each of these limit value terms in turn has a weighting parameter γₖ. The function max(0, Gₖ−Gₖ^{max}) can also be referred to as relu(Gₖ−Gₖ^{max}), that is to say a rectifier.

In some embodiments, α_{P}, α_{Q}<<γ_{k=V,l}. It will result in a much higher level of sanctions than interventions that result in a change in the powers within the respective limit values. In other words, the penalty for a limit value violation is greater than for control within the limit values. In addition, limit value exceedances, for example for the voltage within a voltage band limited by a minimum and maximum voltage limit value, may be sanctioned. In other words, Vᵢ^{min}≤|V_{i,t}|≤Vᵢ^{max} for the network nodes and |I_{l,t}|≤Iₗ^{max} for the lines should be fulfilled during operation. This can be taken into account by appropriate penalty terms within the reward function.

Thus, if aₜ=(ΔP_{1,t}, . . . , ΔP_{F,t}, ΔQ_{1,t}, . . . , ΔQ_{F,t})^{T} is used to indicate an intervention, that is to say a change in the active power ΔP_{i,t} and the reactive power ΔQ_{i,t} at the time t at the network node i, where F denotes the total number of feed-ins/feed-outs, the neural network can be understood as meaning a map f:zₜ^{(m)}→aₜ*. According to the map f (policy function), the neural network trained according to the present invention and/or one of its embodiments determines the most optimal possible intervention aₜ* from a general measured state zₜ^{(m)}=(P_{1,t}, P_{2,t}, . . . , Q_{1,t}, . . . , |V_{1,t}|, . . . φ_{V,1,t}, . . . |I_{1,t}|, . . . φ_{l,1,t}, . . . )^{T}. The intervention at is determined in this case in such a way that the reward function is maximized as much as possible, especially preferably has a value of zero. This is achieved by training the neural network. Alternatively or additionally, other reinforced learning methods, such as actor-critic methods, can be used.

The data zₜ^{(m)}, aₜ* can be acquired or determined and stored during operation of the supply network.

In some embodiments, the learning takes place in such a way that the reward function r(sₜ) is maximized. In other words, limit value violations and, in principle, interventions in the operation of the electricity network are sanctioned. This sanctioning in the reward function technically ensures that as few interventions as possible and as few limit value violations as possible occur during operation of the electricity network. In this case, limit value violations may be weighted more strongly than regulating or controlling interventions within the reward function.

In some embodiments, the neural network determines the vector aₜ=(ΔP_{1,t}, . . . , ΔP_{F,t}, ΔQ_{1,t}, . . . , ΔQ_{F,t})^{T} as control values. In other words, changes in the powers are preferably used as control values or control commands. This enables efficient control, since only the power fed in and/or fed out by typical systems in the electricity network can be controlled. Voltages and/or currents can be controlled, for example, by means of a controllable local mains transformer.

In some embodiments, the learning additionally takes place with synthetic measured values, wherein the synthetic measured values are calculated by means of a state estimation. In other words, additional data for training the neural network are provided through a state estimation and/or simulation. This improves the training of the neural network and thus the control of the electricity network. The synthetic measured values can also be used to determine whether a limit value would be exceeded in a certain situation.

According to the exemplary embodiment shown in the FIGURE, the supply network is an electricity network, in particular a medium-voltage network and/or low-voltage network, for example a local network. In an example method for the reinforced learning of an artificial neural network, the neural network uses a plurality of measured values associated with an electricity network to determine a plurality of control values or control commands for controlling the electricity network. The measured values include technical measurement variables of the electricity network, in particular powers, voltages, voltage magnitudes, branch currents, branch current magnitudes and/or voltage angles and/or branch current angles. All of the measurement variables used or their associated measured values can be referred to as the (extended) state of the electricity network. The neural network is designed to control the electricity network based on the acquired measured values.

For medium-voltage networks or low-voltage networks, comparatively few measured values are typically available. In other words, typically only a subset of the state variables (measurement variables) mentioned is acquired or measured, i.e. zₜ^{(m)}=Cₘzₜ applies. In this case, the (projection) matrix Cₘ with a 1 in the corresponding line represents the connection of a measurement.

Based on the acquired state variables zₜ^{(m)}, the trained neural network basically determines one or more interventions aₜ*, i.e. one or more control values for controlling the electricity network. The neural network or its effect or control can therefore fundamentally be understood as meaning a map f:zₜ^{(m)}→aₜ*.

According to a first step S1 of the method for training such an artificial neural network as described above, control values are thus calculated or determined by the neural network based on a reward function. The reward function is the basis for the reinforced learning of the neural network. The neural network is trained with the reward function in such a way that optimal interventions are approximated with regard to the reward function. Furthermore, the control value is generated in such a way that at least one limit value of a measurement variable of the electricity network for this control value is exceeded or undershot in a time range. The time range is determined in this case in such a way that protective devices of the electricity network, for example fuses, do not trip, i.e. remain trip-free, even though the limit value is exceeded or undershot, i.e. violated, for a short time. In other words, in order to train the neural network, artificial control values are transmitted to the systems in the electricity network and result in a short-term violation of one or more limit values. Due to the short-term nature of these artificial interventions, the protective devices do not trip, and so they do not interfere with the operation of the electricity network. Such interventions that violate limit values are therefore preferably carried out during operation of the electricity network. Thus, the neural network learns during operation of the electricity network. The limit values are in particular voltage limit values, current limit values and/or power limit values. Limit value exceedances and/or limit value undershoots in the above-mentioned sense can be triggered by the training of the neural network.

In a second step S2 of the method, a plurality of measured values of the measurement variables are acquired after the intervention that led to the limit value violation. In other words, at least one measured value is thereby assigned to the intervention that led to the limit value violation. As a result, the control value is associated with the measured value. These form a tuple (zₜ^{(m)}, aₜ*) which is used to train the neural network. This not only provides more training data (tuples) for the neural network, but also trains the neural network in the critical boundary areas of the electricity network. This improves the training of the neural network and thus the control of the electricity network by the neural network.

According to a third step S3 of the method, the neural network is finally trained by means of the calculated control value and the acquired associated measured value. The data (zₜ^{(m)}, aₜ*) can also be stored for this purpose.

If a measurement is missing or a measured value cannot be acquired for a measurement variable, estimates can be used. This can be done by means of a simulation and/or state estimation.

The described procedure for training the neural network can therefore also be referred to as testing of the state (state exploration). During training, the reward function can also be changed. Initially, limit value violations could be weighted more heavily. If these occur less frequently later, their weighting can be reduced. This makes it possible to autonomously adapt the neural network or the underlying model during operation. Furthermore, a model could be completely rejected and the neural network could be retrained.

By virtue of the present method for training the neural network, which is carried out during operation of the electricity network, an improved trained neural network, especially with regard to critical situations, is thus formed. The network trained in this way is used to control the electricity network, thus improving the control of the electricity network. In particular, line overloads and voltage band violations can be avoided or reduced in comparison with conventional regulation/control processes. This enables autonomous efficient operation of medium-voltage and/or low-voltage networks.

Although the teachings herein have been described and illustrated in more detail by way of exemplary embodiments, the scope of the disclosure is not restricted by the disclosed examples, or other variations may be derived therefrom by a person skilled in the art without departing from the scope of protection thereof.

### LIST OF REFERENCE SIGNS

S1 First step
S2 Second step
S3 Third step

What is claimed is:

1. A method for the reinforced learning of an artificial neural network, wherein the neural network uses measured values associated with a supply network to determine a plurality of control values for controlling the supply network, the method comprising:
determining a control value such that at least one limit value of a measurement variable of the supply network is violated in a time range, wherein the time range is determined in such a way that protective devices of the supply network do not trip;
acquiring at least one measured value associated with the control value; and
training the neural network using the calculated control value and the acquired associated measured value.

2. The method as claimed in claim 1, wherein the supply network comprises an electricity network.

3. The method as claimed in claim 2, wherein the supply network is comprises as a medium-voltage network and/or low-voltage network.

4. The method as claimed in claim 1, wherein learning takes place during operation of the supply network.

5. The method as claimed in
claim 1, wherein the time range is less than or equal to one minute.

6. The method as claimed in claim 1, wherein avoided violations of limit values are used as quality parameters of the reinforced learning.

7. The method as claimed in claim 2, wherein the measured values comprise active powers, reactive powers, angles and/or currents of the respective phase at respective network nodes of the electricity network and/or in the respective lines of the electricity network.

8. The method as claimed in claim 2, further comprising feeding changes in active powers and/or reactive powers into the electricity network and/or out due to the control values.

9. The method as claimed in claim 8, wherein the control values are transmitted using a ripple control signal and/or telecontrol signal to a smart meter and/or to a controllable mains transformer and/or to converters of photovoltaic systems and/or to charging stations.

10. The method as claimed in claim 2, wherein
$$r ( {s}_{t} ) = - {α}_{P} {\vert Δ P \vert}^{2} - {α}_{Q} {\vert Δ Q \vert}^{2} - {\sum }_{k} {γ}_{k} max ( 0 , {G}_{k} - {G}_{k}^{max} )$$
is used as the reward function, where Gₖ indicates a measurement variable and Gₖ^{max} indicates its associated limit value, ΔP indicates a change in the active power, ΔQ indicates a change in the reactive power and sₜ=(P_{1,t}, P_{2,t}, . . . , P_{N,t}, Q_{1,t}, Q_{2,t}, . . . , Q_{N,t})^{T} indicates a state of the electricity network at the time t.

11. The method as claimed in claim 10, wherein the learning takes place in such a way that the reward function r(sₜ) is maximized.

12. The method as claimed in claim 10, wherein the neural network determines the vector aₜ=(ΔP_{1,t}, . . . , ΔP_{F,t}, ΔQ_{1,t}, . . . , ΔQ_{F,t})^{T} as control values.

13. The method as claimed in claim 2, wherein the learning additionally takes place with synthetic measured values, wherein the synthetic measured values are calculated by means of a state estimation.

14-15. (canceled)
